(19) United States
(12) Patent Application Publication
(10) Pub. No.: US 2025/0224254 A1
(43) Pub. Date: Jul. 10, 2025

(54) METHODS AND SYSTEMS FOR KIOSK-ASSISTED MAPPING

(71) Applicant: Smartlink Ventures, Inc., Newport, KY (US)

(72) Inventors: Peter J. Thelen, Fort Mitchell, KY (US); Nicholas Duskey, Camden, OH (US); Nathan Denlinger, Dayton, OH (US); Davis Sanders, Dayton, OH (US); Russ Middleton, Cincinnati, OH (US); CJ Dyas, Mason, OH (US)

(21) Appl. No.: 18/941,664

(22) Filed: Nov. 8, 2024

Related U.S. Application Data
(60) Provisional application No. 63/617,502, filed on Jan. 4, 2024.

(51) Int. Cl. G01C 21/00

(52) U.S. Cl. CPC G01C 21/3889; G01C 21/3896

(57) ABSTRACT

Methods and systems are described for mapping systems and applications. A user can obtain a map and driving directions to a location, such as a shopping mall. The system may provide guidance on walking or driving to the shopping mall, including a best place to park. Once the user is parked, the mapping application on the user's smart device may offer an AR view of the surroundings with visual or audible guidance to help the user reach a sub-location, such as a specific store within the shopping mall. In some embodiments, the AR view may be available after clicking on a link available from one of a number of kiosks located at the desired location.

### TECHNICAL FIELD

The present disclosure generally relates to mapping systems.

### BACKGROUND

There exist a variety of mapping solutions, like Google Maps™ or Waze™. These solutions have benefits when driving but lose usefulness when a user enters a building. Users of these prior art systems often use a mobile application on a smartphone. After entering an address, the application will assess the best route to a desired destination. The application typically uses a combination of the smartphone's data service as well as the smartphone's GPS (global positioning system) antenna.

### SUMMARY

One embodiment under the present disclosure comprises a method for providing map directions to a user. The method comprises receiving, at a kiosk, a selection of a desired sub-location, the sub-location comprising a specific location within a larger location; and creating a plurality of map directions configured to guide the user to the sub-location. The method further comprises providing a link for the user to access the plurality of map directions such that the plurality of map directions can be displayed on a computing device operated by the user, wherein the plurality of map directions are displayed to the user in an augmented reality user interface combining the plurality of map directions and one or more images gathered from a camera comprising the computing device.

Another embodiment under the present disclosure comprises a mapping system for providing map directions to a user. The system comprises one or more mapping servers configured to received requests from one or more computing devices to create one or more routes to one or more locations comprising one or more sublocations, the one or more mapping servers further configured to transmit the one or more routes to the one or more computing devices. The system also comprises one or more kiosks in communication with the one or more mapping servers and located at at least one of the one or more locations, the one or more kiosks configured to receive an indication of a presence of the one or more computing devices and to provide access to a route to one or more sublocations.

Another embodiment under the present disclosure is a kiosk for providing directions to a user. The kiosk comprises one or more communication interfaces configured to communicate with one or more mapping servers; and one or more screens configured to display information to one or more users. The kiosk is characterized in that the kiosk is configured to receive an indication from the one or more mapping servers that a user is arriving at a location comprising the kiosk, the location comprising one or more sublocations, the kiosk further configured to display, or provide access, to the user directions from the kiosk to the one or more sublocations upon the user's arrival at the kiosk.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates an example embodiment of a mapping system under the present disclosure;

FIG. 2 illustrates an example embodiment of a mapping kiosk under the present disclosure;

FIG. 3 illustrates an example embodiment of an augmented reality map under the present disclosure;

FIG. 4 illustrates an example embodiment of a kiosk editor under the present disclosure;

FIG. 5 illustrates an example embodiment of a CAD drawing;

FIG. 6 illustrates an example embodiment of an electronic device under the present disclosure; and

FIG. 7 illustrates a flow-chart of a method embodiment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in the realm of mapping systems and methods. Mapping systems, such as Waze, can map out a route of roads to get to a desired location. However, once a user parks their car at the destination (e.g., a mall, hospital, office building, etc.) the mapping system does not provide further guidance on arriving at a specific area of the location (e.g., a specific store, a doctor's office).

Certain aspects of the embodiments disclosed herein provide solutions to these or other challenges. Embodiments include a mobile application and system of kiosks that can help a user arrive at a specific location within a mall, hospital, office park, or other location with numerous sub-locations.

Certain embodiments may provide one or more of the following technical advantages. Embodiments under the current disclosure can provide accurate directions to a specific location within a mall, hospital, or similar location. This can provide users with a quicker route to places like doctors' offices, specific stores within shopping malls, and similar locations. This can save time and may provide a safer route to such locations.

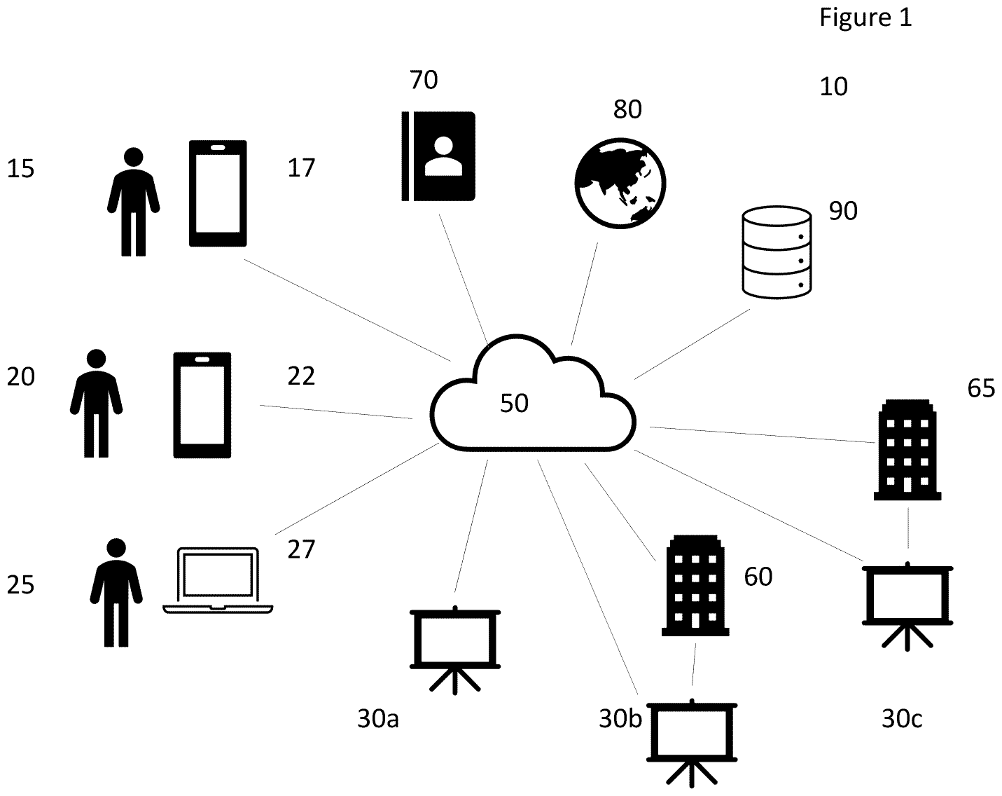

FIG. 1 illustrates one embodiment of a mapping system 10 under the present disclosure. Mapping server(s) 90 can provide mapping services to users 15, 20, 25 with computing devices 17, 22, 27 (e.g., smartphones, computers, tablets, smartwatches, smartglasses, wearables, etc.). For example, a user 15 may use a mobile application provided by mapping server 90 to find directions to a desired address. Mapping server 90 may communicate with computing devices 17, 22, 27 via network 50 (e.g., the Internet, cellular networks, local area networks, Wi-Fi networks, etc. and/or combinations of the foregoing). Mapping server(s) 90 may comprise, or communicate with remote or third-party instances of, address database(s) 70 and map database(s) 80. Address database 70 may store a variety of address and location information. Map database 80 may store a variety of map or road data. Mapping server 90 may, upon receiving a desired address from a user or starting and ending points to a trip, access address database 70 or map database 80 to determine where the desired address is located, and assess what roads or routes the user may take to reach the desired location.

Users may sometimes desire to go to locations like offices 60, 65 (which may comprise malls, hospitals or other similar location with numerous sub-locations). Kiosk(s) 30a/b/c may be located at offices 60, 65 or other locations, like on streets in a city. Kiosks 30a/b/c may be directly communicating via network 50 or may be coupled to local networks at offices 60, 65. When a user 15 desires to go to office 60 they may receive driving or walking directions (or rail, bus, etc.) on their computing device 17 from mapping server 90. Once user 15 arrives at office 60 the driving or walking directions may end in prior art systems. However, in certain embodiments of the present disclosure the mapping system 10 can provide additional directions. Mapping system 10 can provide directions to the best parking lot to use, and/or the best entrance to use to reach a desired sub-location. The user may approach kiosk 30b located at office 60 (within office 60 or in a parking lot or another close location). Any location could comprise multiple kiosks. When the user 15 approaches kiosk 30b they can select a location on a displayed map or list of sub-locations located at office 60. In some embodiments kiosk 30b may know that the user 15 is approaching (via e.g., Bluetooth signals, notification from mapping server 90 that is tracking the location of user 15, or other means). The kiosk 30b can then display a QR (quick response) code. User 15 can scan the QR code with their computing device 17 and the mapping application (or another/related application) can then display directions for arriving at the desired sub-location. In this example kiosk 30b displays a QR code. Other embodiments may display another type of scannable link, allow a Bluetooth or wireless connection between the computing device 17 and kiosk 30b, communicate via NFC (near field communication), or use other means to transmit directions to the sub-location from the kiosk 30b to the computing device 17. Directions to the sub-location preferably comprise an augmented reality (AR) view on the computing device 17. This way, as the user 15 holds up their computing device 17, and moves it around, the display can show arrows or written or oral commands directing the user 15 where to go. In some embodiments the computing device 17 may provide an AR view to a user 15 without an interaction with a kiosk 30b. For example, the computing device 17 could provide an AR view beginning in the parking lot once the user 15 has left their car.

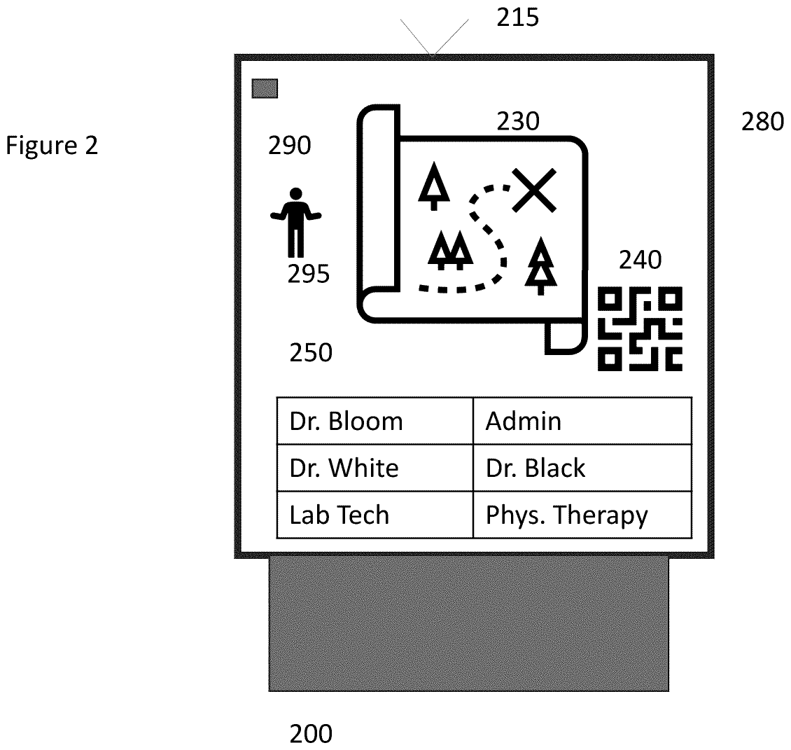

FIG. 2 shows an embodiment of kiosk 260. In this embodiment kiosk 200 is located at a hospital and can display a map 230 of the hospital and various sub-locations and/or a list 250 of sub-locations on a screen 280. Kiosk 200 can comprise a touchscreen or other interacting tools like keyboards, mouse, etc. Kiosk 200 can comprise a camera 290. Kiosk 200 may display images 295, such as advertisements, television stations, videos, or other content. When a user selects a sub-location then kiosk 200 may display a QR code 240 for the user to scan with their e.g., smartphone. QR code 240 may comprise a link to an augmented reality view of the hospital, beginning from e.g., the location of kiosk 200, with arrows or other indicators (and optionally written directions, or audible cues/direction) showing the way to the desired doctor's office or other sub-location within the hospital. Alternatively, kiosk 200 may communicate with a user's smartphone via antenna 215, such as by Bluetooth, NFC, or other means. The augmented reality view on the user's smartphone may continue using the smartphone's cellular data plan. Alternatively, there may be a data transfer between kiosk 200 and the smartphone, such as by e.g., antenna 215.

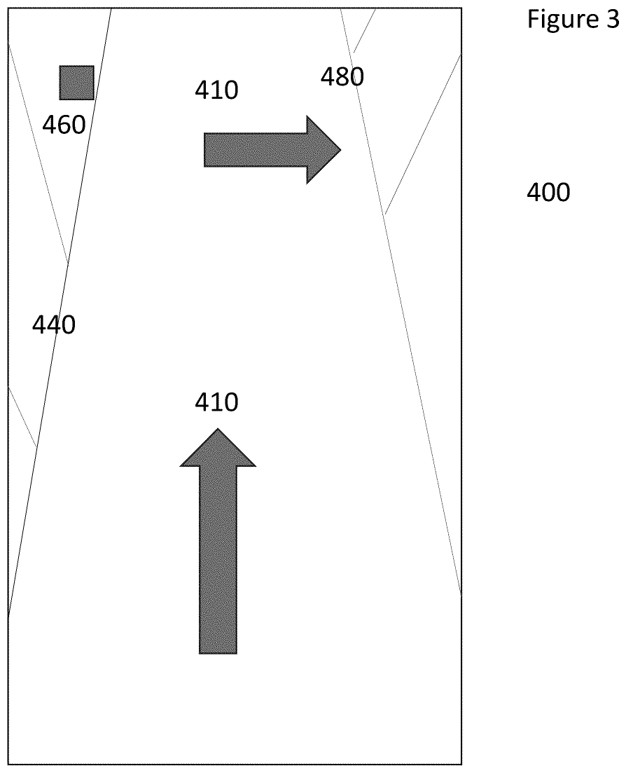

FIG. 3 shows a possible embodiment of a UI 400 of an AR view discussed with respect to FIG. 2. In this example, arrows 410 provide guidance to location 480, e.g., a doctor's office at a hospital. Location 440 is not the desired sub-location but another sub-location at the hospital. Sensor 460 may comprise a Bluetooth antenna or other antenna, device or sensor that may be used to track a user or user computing device. As the user makes their way along the indicated path, the arrows 410 and any other indicators can change as the user's location changes. Directions can also include instructions to take elevators, stairs, escalators, or other similar instructions. For example, a set of directions for a given route may comprise arrows down a first hallway, instructions to go down a set of stairs, and further arrows down a second hallway to the desired sub-location. User computing devices can comprise altimeters, gyroscopes, GPS, or other tracking or position technologies to assist the computing device, kiosks, or central mapping servers to track user/device location.

As a user goes to the desired sub-location, the application provided by mapping server 90 may be able to operate a computing devices camera so as to detect where along the path the user is. In some embodiments the computing device (e.g., a smartphone) may be transmitting data to e.g., mapping server 90 of FIG. 1, which analyzes the video/photos to determine the user's location within the e.g., hospital. In some embodiments a portion or all of the hospital's layout may be downloaded onto the computing device, so the application running on the computing device can detect the user's location without a data connection to the mapping server. In some embodiments, a location (e.g., a hospital) may have a number of kiosks that can detect where various computing devices are for various users. Detection can be via Bluetooth connection, NFC, visual detection via a camera, or other means. The kiosks may detect user locations and may communicate the locations to other kiosks, user computing devices, and/or a central mapping server. Tracking of user location within a hospital or mall could also be done by geofencing. There could be one or more Bluetooth antennas, Wi-Fi spots, or other detection devices to track a user or the user's computing device. Any of these tracking approaches can be used alone or in combination with each other. Tracking information can be shared amongst kiosk(s), user computing device(s), and a central mapping server.

The mapping embodiments described herein can be used in a variety of locations and situations. Locations like hospitals or offices or malls may use these tools. The embodiments described herein may also be used during emergency situations. People in a hospital, office building, university campus, or other location may not know where to go during emergencies. Emergency events could be earthquakes, terrorist attacks, tornadoes, or other dangerous events. During such events users could approach a kiosk and receive directions to bomb shelters, exits, police stations, or other desired locations.

Kiosks (e.g., kiosks 200 of FIG. 2) may be configured to display images 295 (e.g., advertisements). Such images 295 may take up all or part of screen 280. In some embodiments multiple kiosks 200 in a location may be synchronized to run images simultaneously, or in a time series, with an image(s) 295 sequentially appearing amongst multiple kiosks 200. Kiosk 200 can comprise a camera 290 and may be able to detect various characteristics of people using the kiosk 200. Kiosk 200 or mapping server 90 of FIG. 1 may choose images 295 depending on the person using the kiosk 200. For example, advertisements may change for different viewers depending on e.g., age, height, sex, desired location, clothes, or other factors.

In some embodiments kiosk 200 may deliver experiential marketing. For example, the kiosk 200 may offer a UI to try on a product, e.g., sunglasses. Using camera 290, the kiosk 200 can capture images of a user and display them on screen 280, with sunglasses from a nearby store super imposed on the user. The user may be able to interact with screen 280, such as via a touchscreen, and may select different products to try on. Kiosk could even provide the user with a coupon for a local store related to the given products. Or a coupon or advertisement could be pushed to the user's computing device.

Mapping server 90 and/or kiosks 30a/b/c may keep records of where users are going, and what locations or sub-locations they are searching for. This data may be useful for e.g., setting advertisement costs on kiosks, for selling consumer behavior data, and/or other uses.

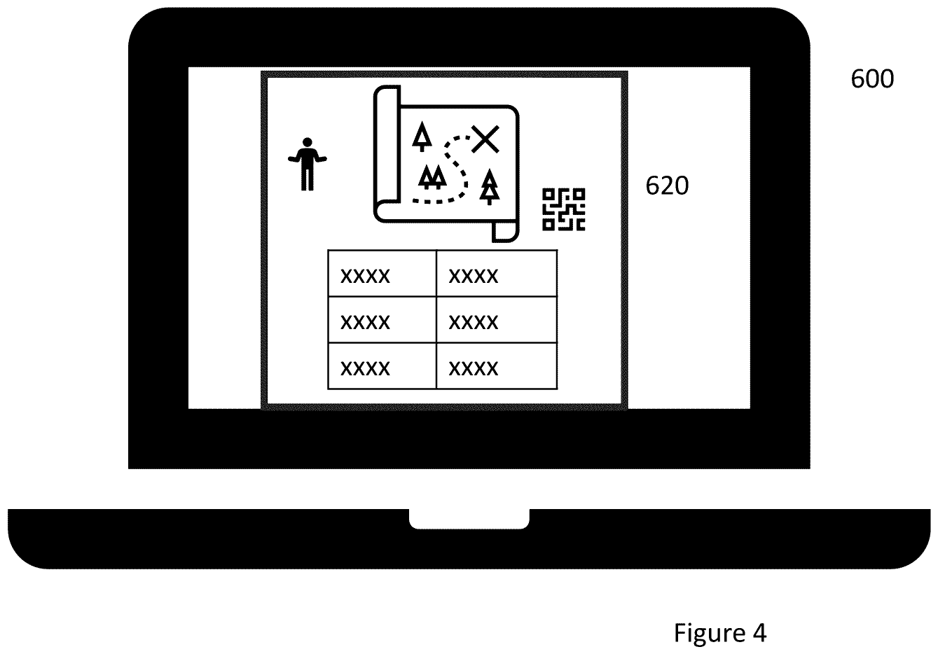

Mapping server 90 can comprise a user interface and computing device allowing a user to change settings for various kiosks 30a/b/c of FIG. 1 or kiosk 200 of FIG. 2. FIG. 4 displays an example embodiment of a possible kiosk edit UI 600. Kiosk edit UI 600 can display a number of kiosks to edit their settings. For example, a user may upload or select new images or advertisements to display. Mapping settings can be changed. For example, a hospital may have construction done and the map of the hospital needs to be changed. A preview image 620 can be shown of any selected kiosk, before, during or after editing or updating its settings.

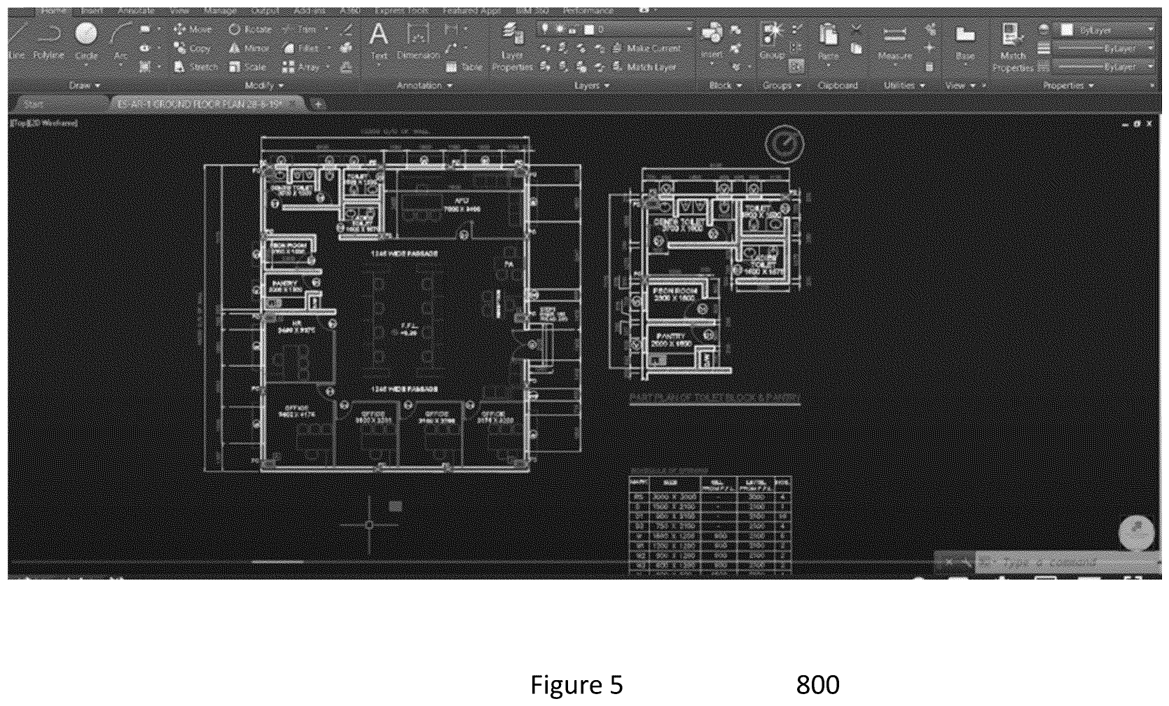

One way that a map can be created of a location can be by uploading CAD (computer aided design) files (or other architectural or design files) to e.g., mapping server 90 of FIG. 1. Mapping server 90 can be configured to ingest e.g., a CAD file 800 of FIG. 5, of e.g., an office building, to analyze the CAD file, and to create, e.g., a two-dimensional map for display in a mobile application or on a kiosk, or a three-dimensional rendering for use in AR views as described herein.

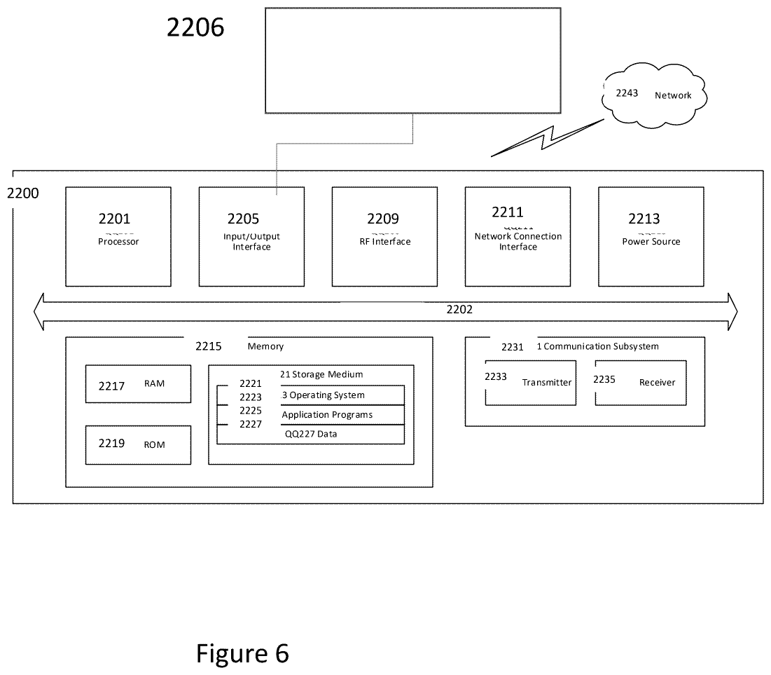

FIG. 6 illustrates an embodiment of an electronic device(s) 2200, such as system 10 of FIG. 1, or components thereof, e.g., mapping server 90, computing devices 17, 22, 27, address database 70, map database 80, kiosks 30a/b/c, configured to implement or perform aspects of the present disclosure. FIG. 6 shows a schematic block diagram of a device 2200 (or components thereof) according to certain embodiments of the present disclosure. Device 2200 can be used to analyze and/or optimize data or variables, such as mapping data; user location search capabilities; user tracking; travel time; and/or other data.

Device 2200 includes processor 2201 that is operatively coupled via a bus 2202 to an input/output interface 2205, a power source 2213, a memory 2215, a RF interface 2209, network communication interface 2211, and/or any other component, or any combination thereof. Certain devices 2200 may utilize all or a subset of the components shown in FIG. 6. The level of integration between the components may vary from one embodiment to another. Further, certain devices 2200 may contain multiple instances of a component, such as multiple processors, memories, transceivers, transmitters, receivers, etc.

The processor 2201 is configured to process instructions and data and may be configured to implement any sequential state machine operative to execute instructions stored as machine-readable computer programs in memory 2215. Processor 2201 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 2201 may include multiple central processing units (CPUs).

In the example, input/output interface 2205 may be configured to provide an interface or interfaces to an input device, output device, or one or more input and/or output devices, such as screen 2206. Examples of an output device include a speaker, a sound card, a video card, a display, a monitor, a printer, an actuator, an emitter, a smartcard, another output device, or any combination thereof. An input device may allow a user to capture information into device 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, an altimeter, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2213 is structured as a battery or battery pack. Other types of power sources, such as an external power source (e.g., an electricity outlet), photovoltaic device, or power cell, may be used. The power source 2213 may further include power circuitry for delivering power from the power source 2213 itself, and/or an external power source, to the various parts of device 2200 via input circuitry or an interface such as an electrical power cable.

Memory 2215 may be configured to include memory such as random access memory (RAM) 2217, read-only memory (ROM) 2219, programmable read-only memory (PROM), erasable programmable read-only memory (EPROM), electrically erasable programmable read-only memory (EEPROM), magnetic disks, optical disks, hard disks, removable cartridges, flash drives, other storage medium 2221, and so forth. In one example, the memory 2215 includes one or more application programs 2225, an operating system 2223, web browser application, a widget, gadget engine, or other application, and corresponding data 2227. Memory 2215 may store, for use by the system 2200, any of a variety of various operating systems or combinations of operating systems. An article of manufacture, such as one including a simulation system or communication system may be tangibly embodied as or in memory 2215, which may be or comprise a device-readable storage medium.

Processor 2201 may be configured to communicate with an access network or other network using the RF interface 2209 or network connection interface 2211. The RF interface 2209 or network connection interface 2211 may comprise one or more communication subsystems and may include or be communicatively coupled to an antenna. In the illustrated embodiment, communication functions of the RF interface 2209 or network connection interface 2211 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Device 2200 can perform methods such as described further herein.

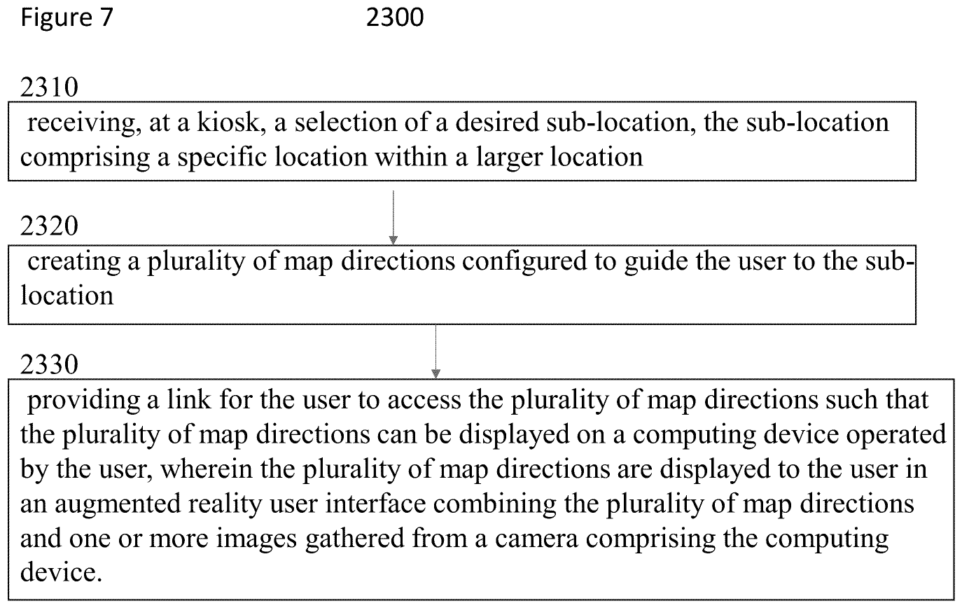

A possible method embodiment under the present disclosure is shown in FIG. 7. Method 2300 comprises a method of providing map directions to a user. Step 2310 is receiving, at a kiosk, a selection of a desired sub-location, the sub-location comprising a specific location within a larger location. Step 2320 is creating a plurality of map directions configured to guide the user to the sub-location. Step 2330 is providing a link for the user to access the plurality of map directions such that the plurality of map directions can be displayed on a computing device operated by the user, wherein the plurality of map directions are displayed to the user in an augmented reality user interface combining the plurality of map directions and one or more images gathered from a camera comprising the computing device. Method 2300 can comprise multiple alternative embodiments with additional or alternative steps.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor-as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Conclusion

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method of providing map directions to a user, the method comprising:
receiving, at a kiosk, a selection of a desired sub-location, the sub-location comprising a specific location within a larger location;
creating a plurality of map directions configured to guide the user to the sub-location; and
providing a link for the user to access the plurality of map directions such that the plurality of map directions can be displayed on a computing device operated by the user comprising a camera, wherein the plurality of map directions are displayed to the user in an augmented reality user interface combining the plurality of map directions and one or more images gathered from the camera.

2. A mapping system for providing map directions to a user, the system comprising:
one or more mapping servers configured to received requests from one or more computing devices to create one or more routes to one or more locations comprising one or more sublocations, the one or more mapping servers further configured to transmit the one or more routes to the one or more computing devices;
one or more kiosks in communication with the one or more mapping servers and located at at least one of the one or more locations, the one or more kiosks configured to receive an indication of a presence of the one or more computing devices and to provide access to a route to one or more sublocations.

3. A kiosk for providing directions to a user, the kiosk comprising:
one or more communication interfaces configured to communicate with one or more mapping servers;
one or more screens configured to display information to one or more users;
wherein the kiosk is configured to receive an indication from the one or more mapping servers that a user is arriving at a location comprising the kiosk, the location comprising one or more sublocations, the kiosk further configured to display, or provide access, to the user directions from the kiosk to the one or more sublocations upon the user's arrival at the kiosk.
